(19) United States
(12) Patent Application Publication
(10) Pub. No.: US 2006/0163282 A1
(43) Pub. Date: Jul. 27, 2006

(54) Dispensing device

(75) Inventor: Hideya Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Chuo-ku (JP)

(21) Appl. No.: 11/390,335

(22) Filed: Mar. 28, 2006

Related U.S. Application Data
(63) Continuation of application No. PCT/JP04/14383, filed on Sep. 30, 2004.

(30) Foreign Application Priority Data
Oct. 3, 2003 (JP) JP2003-346426

(51) Int. Cl. B67D 5/52

(52) U.S. Cl. 222/135; 222/94

(57) ABSTRACT

A dispensing device including a plurality of containers respectively accommodating liquid contents, and a pump device in fluid communication with the plurality of containers. The pump device includes a first cylinder in fluid communication with the first container, a first piston provided inside the first cylinder, a second cylinder in fluid communication with the second container, and a second piston provided inside the second cylinder. The pump device further includes a lever type handle that simultaneously operates the first and second pistons. Liquid content discharge paths being respectively in fluid communication with the cylinders communicate with one discharge valve upstream of a discharge outlet, allowing the liquid contents discharged from each cylinder to pass through the discharge valve to join into one.

### CROSS-REFERENCE TO RELATED APPLICATIONS

This application is based upon and claims the benefit of priority from PCT Application No. JP/2004/014383, filed on Sep. 30, 2004, and Japanese Patent Application No. 2003-346426, filed Oct. 3, 2003, the entire contents of each of which is incorporated herein by reference.

### FIELD OF THE INVENTION

The present invention relates to a dispensing device which dispenses multiple liquid contents simultaneously by means of a pumping unit.

### DESCRIPTION OF THE RELATED ART

Conventionally known as a two-part type,hair cosmetic is a two-part type hair dye which is composed of, e.g., a first agent containing an oxidation dye and a second agent containing an oxidizing agent such as hydrogen peroxide. Also known is a two-part type hair bleach which is composed of a first agent containing an alkaline agent and a second agent containing hydrogen peroxide.

In terms of storage stability of such a hair cosmetic, the first agent and the second agent are kept in respective separate containers, and will be mixed at the time of use. The first agent and the second agent can be simultaneously dispensed using a device, for example, disclosed in Japanese Patent Laid-Open Publication No. 2000-297018, in which two aerosol containers are provided with a manipulation member that enables simultaneous depression of the stems thereof.

Another device disclosed in Japanese Utility Model Laid-Open Publication No. Hei 5-29982 has two pump containers provided with an adapter for coupling the discharge stems to one discharge outlet. A discharge button provided on the adapter is depressed to thereby activate two pumps at the same time so that the two liquids are discharged through the one discharge outlet. Still another device for simultaneously discharging two liquids is also known which is provided with a trigger pump (Japanese Patent Laid-Open Publication No. Hei 8-229465).

However, an aerosol container is costly to manufacture. The container also needs to be degassed and then discarded as can wastes at much expense in time and effort. Furthermore, since the container allows the liquid content to be continuously discharged while the stem is being depressed, the discharge cannot be controlled quantitatively.

On the other hand, the pump container requires a suitable force to depress the stems of the two pump devices at the same time using the one discharge button. In particular, the discharge operation of a hair cosmetic such as hair dyes is typically carried out with one hand. Accordingly, it can not be carried out with an effortless force to depress the discharge button with one finger to simultaneously depress the stems of the two pump devices while grasping the pump container containing two liquids with the one hand.

As described in Japanese Patent Laid-Open Publication No. Hei 8-229465, the trigger pump may be used to discharge the two agents. In this case, once the two agents have been discharged using the trigger pump, a liquid mixture of the two agents will remain in the cylinder of the trigger pump. Accordingly, such a problem may rise that a chemical reaction between the two agents will progress in the cylinder until the container is used again.

### SUMMARY OF THE INVENTION

In view of these problems, it is an object of the present invention to enable liquid contents filled in a plurality of containers to be dispensed at the same time using a pump device through a simple, effortless operation as well as to prevent the agents from being mixed in the cylinder.

The present invention relates to use of a pump device to simultaneously dispense liquid contents from a plurality of containers, the liquid contents being accommodated in their respective containers. To this end, the pump device is provided with a cylinder and a piston for each container, a lever designed to act upon each piston at the same time, and one discharge valve upstream of a discharge outlet. Furthermore, a liquid content discharge path in fluid communication with each cylinder is designed to communicate with the discharge valve. This arrangement prevents the liquid contents from being mixed with each other in the cylinders. It was also found that only one discharge valve acts as a sufficient check valve for interrupting a backward flow of each liquid content opposite to the direction of discharge, thereby making it possible to reduce the number of parts and thus manufacturing costs.

That is, the present invention provides a dispensing device that includes a plurality of containers each for accommodating a liquid content, a pump device in fluid communication with the plurality of containers, and a lever for actuating a piston of the pump device, wherein one lever operation allows the liquid contents accommodated in the respective containers to be discharged simultaneously through a discharge outlet. The pump device has, at least, a first cylinder in fluid communication with a first container, a first piston provided within the first cylinder, a second cylinder in fluid communication with a second container, and a second piston provided within the second cylinder. The lever acts upon each piston at the same time, and each liquid content discharge path in fluid communication with each cylinder communicates with one discharge valve upstream of the discharge outlet. This arrangement allows the liquid contents discharged from each cylinder to pass through the discharge valve and be discharged together.

Also provided is a hair cosmetic dispensing tool in which a first agent and a second agent of a hair cosmetic are filled respectively in the first container and the second container of the dispensing device according to the present invention.

According to the dispensing device of the present invention, a predetermined amount of each of the liquid contents accommodated respectively in a plurality of containers can be dispensed at the same time. Furthermore, the discharge valve is provided upstream of the discharge outlet, so that the discharge path of each liquid content is in fluid communication with the discharge valve. This arrangement makes it possible to prevent the liquid contents from being mixed with each other within the cylinders. The dispensing device is also designed such that only one discharge valve acts as a check valve for interrupting a backward flow opposite to the direction of discharge, thereby making it possible to reduce the number of parts and thus manufacturing costs.

Furthermore, the dispensing device according to the present invention may also be provided with a lever type handle which acts upon the first piston and the second piston at the same time. In this case, this arrangement allows for gripping the dispensing device with one hand and placing fingers on the lever to actuate the lever with one effortless lever operation, thereby discharging the liquid contents from respective containers. That is, typically, a push button provided on an aerosol container or a pump container as a manipulation member is designed to perform a depressing operation with one finger. This arrangement is thus practically difficult to operate with multiple fingers, thereby causing a user to feel that the operation requires an effort to discharge two liquids. However, with the lever provided according to the present invention, it is possible to readily place multiple fingers on the lever for a discharge operation with an effortless force. In particular, the lever type handle can be formed to be wide in width. This arrangement would facilitate placing multiple fingers on the lever for manipulations, thereby making it possible to provide a discharge operation with a further reduced effortless force.

### BRIEF DESCRIPTION OF THE DRAWINGS

FIG. 1A is a sectional view illustrating an initial state of a dispensing device 100A;

FIG. 1B is a sectional view illustrating an initial state of the dispensing device 100A;

FIG. 2A is a sectional view illustrating an operation of the dispensing device 100A;

FIG. 2B is a sectional view illustrating an operation of the dispensing device 100A;

FIG. 2C is a sectional view illustrating an operation of the dispensing device 100A;

FIG. 3A is a perspective view illustrating a dispensing device 100B provided with a grip portion;

FIG. 3B is a side view illustrating the dispensing device 100B provided with the grip portion;

FIG. 3C is a bottom view illustrating the dispensing device 100B provided with the grip portion;

FIG. 4A is a front view illustrating a dispensing device 100C provided with a grip portion;

FIG. 4B is a side view illustrating the dispensing device 100C provided with the grip portion;

FIG. 4C is an exploded perspective view illustrating the dispensing device 100C provided with the grip portion;

FIG. 5A is a perspective view illustrating a dispensing device 100D provided with a grip portion;

FIG. 5B is a side view illustrating the dispensing device 100D provided with the grip portion;

FIG. 5C is a bottom view illustrating the dispensing device 100D provided with the grip portion;

FIG. 6A is a perspective view illustrating a dispensing device 100E provided with a case;

FIG. 6B is a side view illustrating the dispensing device 100E provided with the case;

FIG. 6C is a bottom view illustrating the dispensing device 100E provided with the case;

FIG. 7A is a front view illustrating the dispensing device 100A covered with a tip member;

FIG. 7B is a sectional view illustrating the dispensing device 100A covered with the tip member;

FIG. 8A is a front view illustrating the dispensing device 100A covered with a brush-shaped tip member;

FIG. 8B is a sectional view illustrating the dispensing device 100A covered with the brush-shaped tip member;

FIG. 9A is a front view illustrating the dispensing device 100A provided with a brush;

FIG. 9B is a partially sectional view illustrating the dispensing device 100A provided with the brush;

FIG. 10A is a front view illustrating the dispensing device 100A provided with a brush-shaped application tool;

FIG. 10B is a sectional view illustrating the dispensing device 100A provided with the brush-shaped application tool;

FIG. 11A is a front view illustrating the dispensing device 100A provided with a hair clipper type application tool;

FIG. 11B is a sectional view illustrating the dispensing device 100A provided with the hair clipper type application tool;

FIG. 12A is a partially sectional view illustrating the dispensing device 100A provided with a hair dyeing application tool; and

FIG. 12B is a partially sectional view illustrating the dispensing device 100A provided with the hair dyeing application tool.

### DETAILED DESCRIPTION OF THE PREFERRED EMBODIMENTS

Now, the present invention will be described below in more detail with reference to the accompanying drawings. Throughout the drawings, the same reference symbols denote the same or equivalent components.

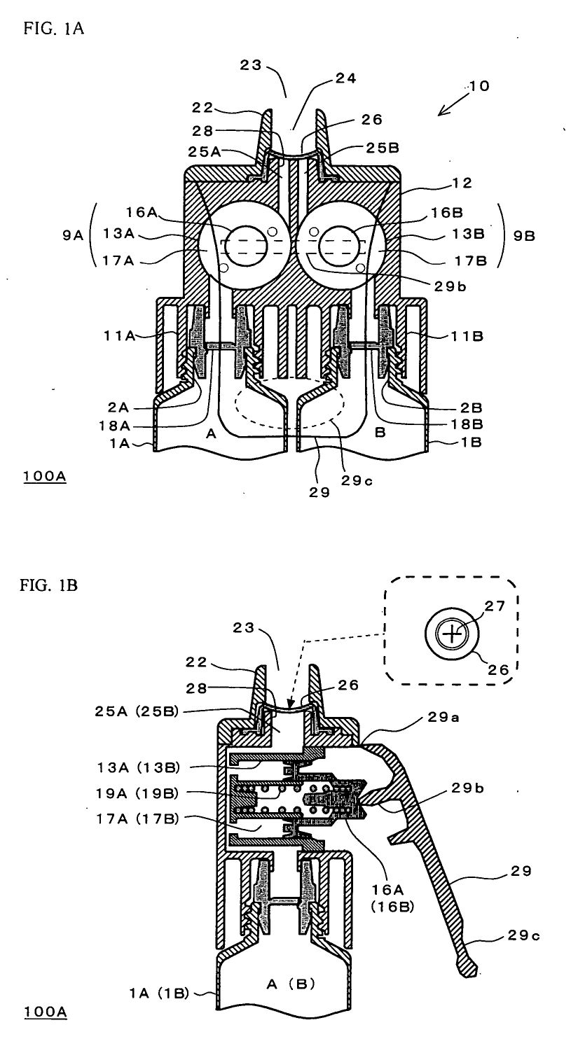

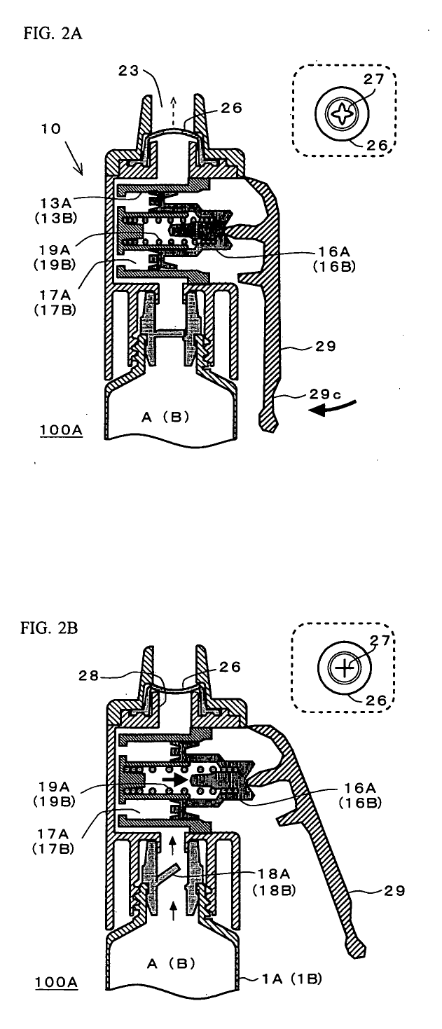

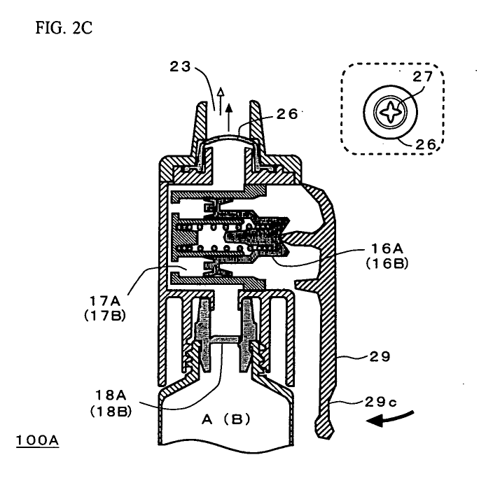

Each of FIG. 1A and FIG. 1B is a sectional view illustrating an initial state of a dispensing device 100A according to an embodiment of the present invention. Specifically, FIG. 1A is a sectional view taken in parallel to the direction of an arrangement of two containers 1A and 1B, and FIG. 1B is a sectional view taken perpendicularly to the direction of the aforementioned sectional view. FIGS. 2A, 2B, and 2C are a sectional view illustrating an operation of the dispensing device 100A.

The dispensing device 100A includes a first container 1A for accommodating a first liquid content A, a second container 1B for accommodating a second liquid content B, and a pump device 10 which caps the top of the containers 1A and 1B. Mouth portions 2A and 2B of the containers 1A and 1B are detachably screwed into container receiving portions 11A and 11B of the pump device 10, respectively.

The pump device 10 has a pump portion 9A including a cylinder 13A and a piston 16A, and a pump portion 9B including a cylinder 13B and a piston 16B, in which the first cylinder 13A in fluid communication with the first container 1A and the second cylinder 13B in fluid communication with the second container are disposed parallel to each other. Each of the cylinders 13A and 13B extends perpendicularly to the longitudinal direction of the containers 1A and 1B. Furthermore, the pistons 16A and 16B are provided in the cylinders 13A and 13B, respectively. The pistons 16A and 16B and the cylinders 13A and 13B define measuring chambers 17A and 17B, which are in turn provided therein with spring members 19A and 19B which repel the force exerted to push the pistons 16A and 16B into the cylinders 13A and 13B, respectively.

As shown in FIG. 1A, the parallel arrangement of the two cylinders 13A and 13B allows the two pistons 16A and 16B to be displaced in the same direction in order to operate the two pump portions 9A and 9B. It is thus made possible to manipulate only one lever type handle 29 in order to displace the two pistons 16A and 16B at the same time and thereby simultaneously discharge the liquid contents through the two pump portions 9A and 9B.

Here, the cylinders 13A and 13B may be formed of a synthetic resin such as high-density polyethylene or polypropylene, while the pistons 16A and 16B may be formed of a synthetic resin such as low-density polyethylene.

The measuring chamber 17A in the first cylinder 13A is in fluid communication with the mouth portion 2A of the first container 1A via an intake valve 18A, while the measuring chamber 17B in the base portion of the second cylinder 13B is in fluid communication with the mouth portion 2B of the second container 1B via an intake valve 18B.

As the intake valves 18A and 18B, it is possible to employ a resin spring valve, one-point valve, three-point valve, ball valve or the like. Furthermore, the intake valves 18A and 18B are preferably provided at the mouth portion of the containers 1A and 1B such that the intake valves 18A and 18B remain attached to the containers 1A and 1B when each of the containers 1A and 1B is removed from the container receiving portions 11A and 11B while the dispensing device 100A is being used. This arrangement prevents air from flowing into the containers 1A and 1B when the containers 1A and 1B are removed from the container receiving portions 11A and 11B. Accordingly, it is possible to prevent degradation by oxidation of the liquid contents which would be otherwise caused by air flowing into the containers. When the containers 1A and 1B are attached again to the container receiving portions 11A and 11B to be used, the so-called “air inclusion” can also be prevented, at the time of occurrence of which the liquid contents would be mixed with air to be discharged from the dispensing device 10A, thereby causing an indeterminate amount of the liquid contents to be discharged.

A discharge nozzle 22 is formed perpendicularly to the direction of displacement of the pistons 16A and 16B (i.e., in the longitudinal direction of the containers). Furthermore, at the inner base portion of the discharge nozzle 22 disposed upstream from a discharge outlet 23, there is provided one discharge valve 26 as a check valve which is closed when the cylinder is under a negative pressure and opened when it is pressurized. Although discharge paths 25A and 25B are separately formed from each of the measuring chambers 17A and 17B to the discharge nozzle 22, both the discharge paths 25A and 25B are in fluid communication with the discharge valve 26, such that the liquid contents A and B are mixed with each other and discharged downstream of the discharge valve 26.

Accordingly, the dispensing device 100A allows the one discharge valve 26 to serve as both the discharge valve of the first liquid content A and that of the second liquid content B, thereby making it possible to reduce the number of parts and thus manufacturing costs. Furthermore, upon passing through the discharge valve 26, there occurs a turbulent flow of each of the liquid contents A and B, which will be thus well mixed with each other in a mixing space 24 defined by the discharge nozzle 22 and then discharged therefrom.

In the area encircled with a dashed line in FIG. 1B, there is shown a plan view of the discharge valve 26 when viewed from the discharge outlet 23. The discharge valve 26 is formed of a cylindrical elastic member with a bottom. At the center of the bottom portion, there is formed a cross-shaped slit 27, which is designed to open when the bottom portion is deformed.

Inside the discharge valve 26, there is provided a check valve actuation restricting member 28. The check valve actuation restricting member 28 does not interfere with the discharge valve 26 when the discharge valve 26 is deformed to protrude away from the check valve actuation restricting member 28. However, the check valve actuation restricting member 28 prevents the discharge valve 26 from being deformed to open when the discharge valve 26 is going to deform and protrude towards the check valve actuation restricting member 28. Such a combination of the discharge valve 26 with the check valve actuation restricting member 28 provides a simple structure ensuring that the discharge valve 26 functions as the check valve to interrupt backward flows.

The present invention is not limited to the discharge valve 26 which has the slit 27 and is formed out of an elastic member or the combination of the discharge valve 26 with the check valve actuation restricting member 28, but it is also acceptable to employ, as the discharge valve disposed upstream from the discharge outlet 23, a check valve structure such as a resin one-point or three-point valve used with a pump dispenser, or a metal or resin ball valve.

As shown in FIG. 1B, end 29a of the plate-shaped lever type handle 29 is pivotally coupled to the outer base portion of the discharge nozzle 22. The lever type handle 29 is wide in width and has a projection portion 29b which simultaneously abuts against the protruded portion of the first piston 16A and the second piston 16B. The lever type handle 29 being wide and plate-shaped allows a plurality of fingers to be placed thereon at the same time. Thus, depressing the other end portion 29c of the lever type handle 29 toward the containers 1A and 1B makes simultaneous displacing of the first piston 16A and the second piston 16B inwardly by an effortless force according to the principle of lever with the end 29a coupled to the base portion of the discharge nozzle 22 acting as the fulcrum and the projection portion 29b acting as the point of application.

In addition to the lever type handle 29 being wide and thus allowing a plurality of fingers to be placed on the lever, a recessed portion formed on the lever type handle 29, at which the lever type handle 29 is depressed, can further facilitate the depression of the lever type handle.

On the other hand, the first and second liquid contents to be filled respectively in the containers 1A and 1B may be various agents that start chemical reactions by mixing the two agents. For example, a variety of two-part type hair dyes, bleach agents, hot-shaving agents, or adhesive agents.

The containers 1A and 1B are preferably deformable so as to shrink in internal volume as the liquid contents are discharged. Examples of such containers include a tube container or pouch container (bag) which is formed of a soft flexible material such as polyethylene or polypropylene, a container with a movable inner plate which is gradually raised from the bottom of the container toward the pump device as the liquid content is discharged, and a delaminated bottle with a container having a laminated structure of an inner layer and an outer layer, in which the inner layer is delaminated causing the inner layer container to be reduced in volume when the inner layer container is reduced in pressure or volume as the liquid content is discharged.

The constituent material of the containers 1A and 1B preferably has an oxygen barrier property corresponding to the type of liquid contents to be accommodated therein. For example, suppose that the dispensing device 100A is used as a tool for discharging a two-part type hair dye composed of a first agent containing an oxidation dye and a second agent containing hydrogen peroxide. In this case, the second container 1B receiving the first agent preferably has a laminated structure which includes an outer layer formed of a polyolefin-based resin such as low-density or high-density polyethylene or polypropylene. The laminated structure also includes an intermediate layer which is an oxygen gas barrier layer formed of such as ethylene-vinyl alcohol copolymer film or polyamide film of meta-xylene diamine, and more preferably a cyclic polyolefin layer which has good moisture and oxidation dye barrier properties. Further included is an inner layer formed of polyolefin (see Japanese Patent Application Laid-Open No. 2002-345548). On the other hand, the first container 1A receiving the second agent preferably has an outer layer formed of low-density polyethylene and an inner layer formed of linear low-density polyethylene, and is permeable to oxygen gas (Japanese Patent Application Laid-Open No. 2002-87418).

To use the dispensing device 100A, first, the pump device 10 is gripped with one hand and one's fingers are placed on the lever type handle 29, and then the lever type handle 29 is depressed as indicated by the arrow in FIG. 2A. This operation causes the first and second pistons 16A and 16B to be simultaneously displaced into the respective cylinders 13A and 13B, such that the spring members 19A and 19B are compressed and each of the measuring chambers 17A and 17B is pressurized. The pressure causes the air inside the measuring chambers 17A and 17B to be discharged through the discharge valve 26 via the discharge paths 25A and 25B, respectively.

Next, the depression of the lever type handle 29 is released. As shown in FIG. 2B, this causes each of the pistons 16A and 16B to be pushed back by the repulsive force of the spring members 19 that have been compressed. This causes the measuring chambers 17A and 17B to be increased in volume and reduced in pressure therein, and the intake valves 18A and 18B are opened, thereby allowing the liquid contents A and B to be drawn from the containers 1A and 1B into the measuring chambers 17A and 17B, respectively. At this time, although a force also acts upon the discharge valve 26 so as to be deformed toward the measuring chambers 17A and 17B, the check valve actuation restricting member 28 which is present on the discharge path 25A and 25B sides (on the upstream sides) prevents this deformation. It is thus ensured that the discharge valve 26 will be never opened but kept closed.

Then, as shown in FIG. 2C, the lever type handle 29 is depressed again. This causes the measuring chambers 17A and 17B to be reduced in size, the intake valves 18A and 18B to be closed, and the discharge valve 26 to be opened. The first liquid content A having been drawn into the first measuring chamber 17A and the second liquid content B having been drawn into the second measuring chamber are mixed with each other and discharged at the same time through the discharge outlet 23.

From this time onward, the lever type handle 29 is depressed and released repeatedly, and the first liquid content A and the second liquid content B can be discharged at the same time through the discharge outlet 23.

In this case, the amounts of discharge of the liquid content A and the liquid content B are determined by the effective areas of the pistons 16A and 16B and the displacements of the pistons 16A and 16B, respectively. The effective areas and the displacements of the pistons 16A and 16B can be adjusted as appropriate, thereby allowing a fixed amount of liquid mixture of the first and second liquid contents A and B to be dispensed. Furthermore, since the projection portion 29b of the lever type handle 29 is kept in contact with the protruded portions of the pistons 16A and 16B over the entire stroke of the lever type handle 29, the ratio of the amount of discharge of the first liquid content A to that of the second liquid content B is determined by the ratio of the effective area of the piston 16A to that of the piston 16B. Accordingly, the user can obtain a constant mixing ratio between the first liquid content A and the second liquid content B irrespective of the amount of discharge of the liquid mixture. Thus, the user has only to adjust the amount of depression of the lever type handle 29, thereby making it possible to readily obtain a desired amount of liquid mixture at a constant mixing ratio.

Furthermore, the lever type handle 29 is used to displace the two pistons 16A and 16B inwardly at the same time, thereby making it possible to discharge the first liquid content A and the second liquid content B with an effortless force on the lever in accordance with the lever principle.

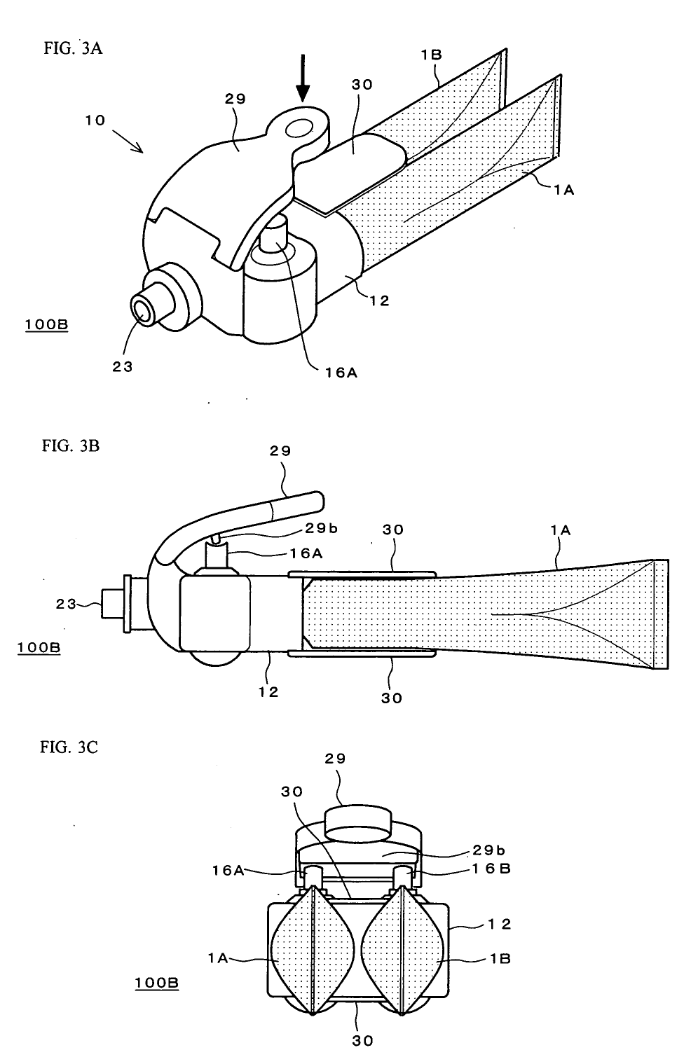

A dispensing device 100B of FIG. 3A is a modified example of the dispensing device 100A of FIGS. 1A and 2B, FIG. 3B being its side view, FIG. 3C being its bottom view. The dispensing device 100B includes a pair of opposing grip portions 30 which are formed on a main-body housing 12 of the pump device 10. The grip portions 30 are formed of plate-shaped members which extend from the main-body housing 12 in the longitudinal direction of the containers 1A and 1B so as to sandwich the containers 1A and 1B, attached to the pump device 10, on their sides.

The grip portions 30 allow the user to grip the dispensing device 100B with one hand and easily apply a force to the lever type handle 29 when depressing the lever type handle 29 in the direction shown by the arrow. In particular, suppose that the liquid containers 1A and 1B are a tube container or pouch container which is formed of a soft flexible material. In this case, a force cannot be easily applied to the lever type handle 29 while directly grasping the containers 1A and 1B and the lever type handle 29 with a hand because the containers 1A and 1B are deformed. However, gripping the grip portions 30 makes it easier to depress the lever type handle 29.

Furthermore, the provision of the grip portion 30 facilitates attachment of the containers 1A and 1B in using the dispensing device 100B because the containers 1A and 1B can be attached to the pump device 10 along the grip portion 30. Furthermore, even when an unexpected force is exerted on the containers 1A and 1B during use of the dispensing device 100B, it is possible to prevent the containers 1A and 1B from being dislodged from the pump device 10.

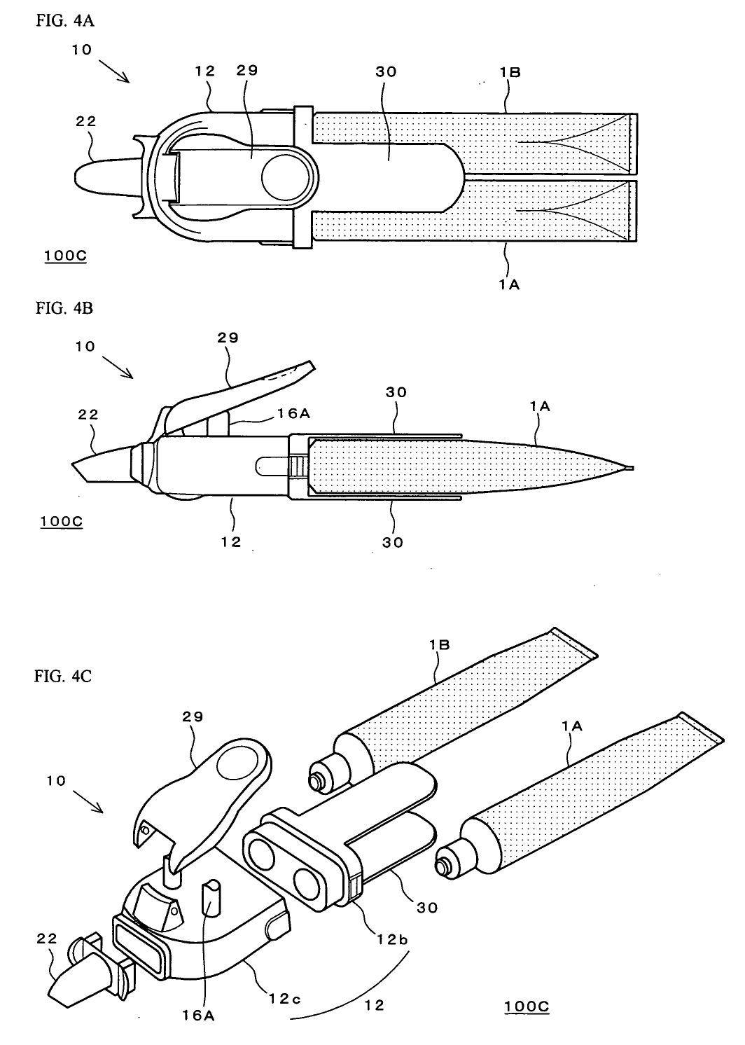

A dispensing device 100C illustrated in FIGS. 4A, 4B, and 4C also has the grip portion 30, like the dispensing device 100B of FIGS. 3A, 3B, and 3C. However, the dispensing device 100C allows the containers 1A and 1B to be freely attached to and detached from the pump device 10. Additionally, the pump device 10 itself is designed such that the parts such as a lower housing 12b having the grip portion 30 and a container attachment portion, an upper housing 12c having a cylinder therein, the lever type handle 29, and the discharge nozzle 22 can be easily assembled and disassembled. This design allows the pump device 10 to be readily cleaned.

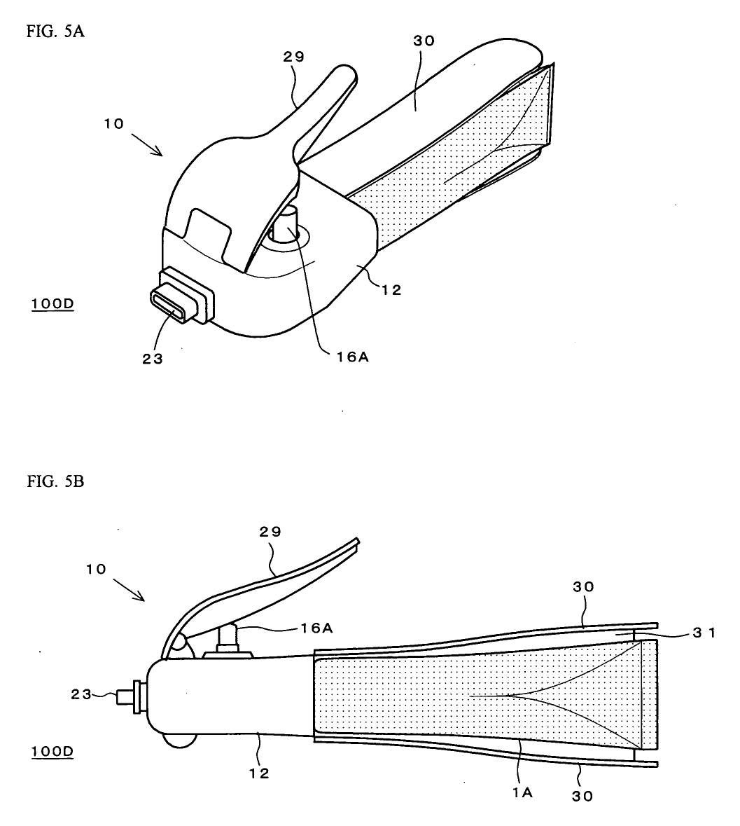

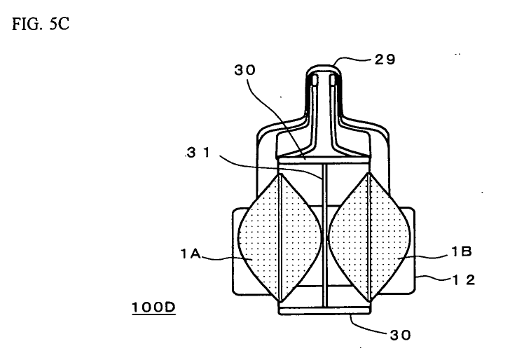

A dispensing device 100D illustrated in FIGS. 5A, 5B, and 5C is also a modified embodiment of the dispensing device 100A of FIGS. 1A and 1B, and has the grip portion 30 on the main-body housing 12 as well. However, the dispensing device 100D includes a grip portion 30 extending to the distal end of the containers 1A and 1B. In this arrangement of the dispensing device 100D, to prevent a deformation caused by the grip portion 30 being deflected, a support plate 31 is provided between the pair of opposing grip portions 30.

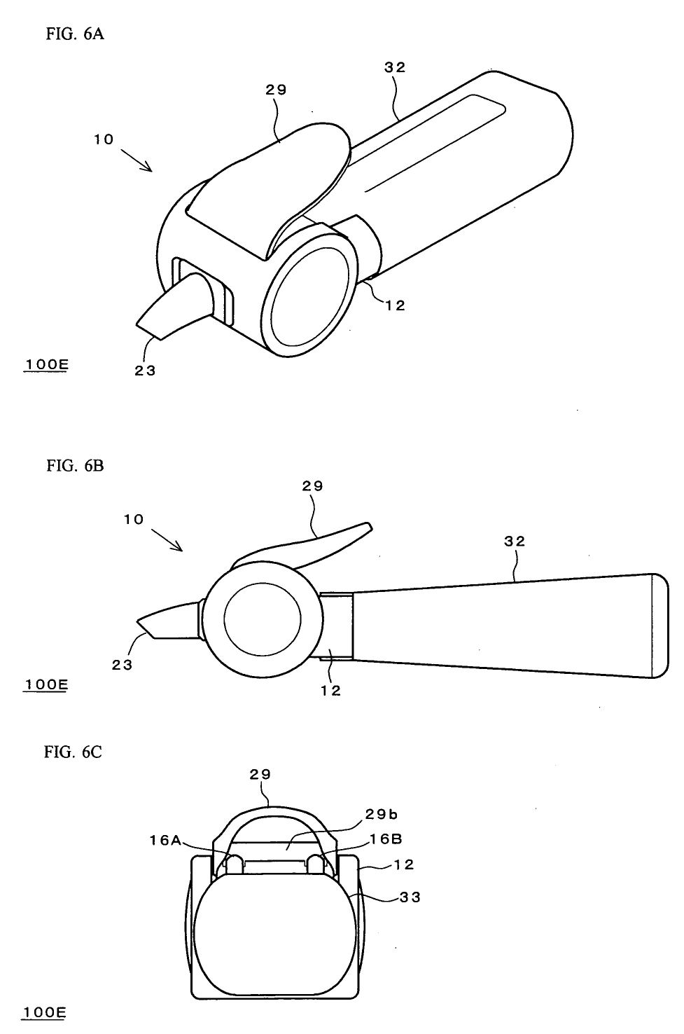

A dispensing device 100E illustrated in FIGS. 6A, 6B, and 6C is provided, instead of the grip portion 30, with a case 32 that encloses the containers 1A and 1B. The case detachably fits onto the main-body housing 12 of the pump device 10.

The present invention can include various modifications. For example, in the dispensing device 100A of FIGS. 1A and 1B, the discharge nozzle 22 may also be formed parallel to the direction of displacement of the pistons 16A and 16B. Furthermore, the angle between the direction of displacement of the pistons 16A and 16B and the longitudinal direction of the containers 1A and 1B is not limited to a right angle.

Furthermore, in the dispensing device 10A, a third container and a third cylinder in fluid communication with the third container may also be provided, such that a third piston in the third cylinder can also be displaced inwardly using the lever type handle 29. In this arrangement, one lever operation allows the first, second, and third liquid contents to be discharged at the same time.

Furthermore, any one of the aforementioned dispensing devices may be provided, at the tip portion of the discharge nozzle 22, with an application tool such as a comb or brush according to the use of the dispensing device.

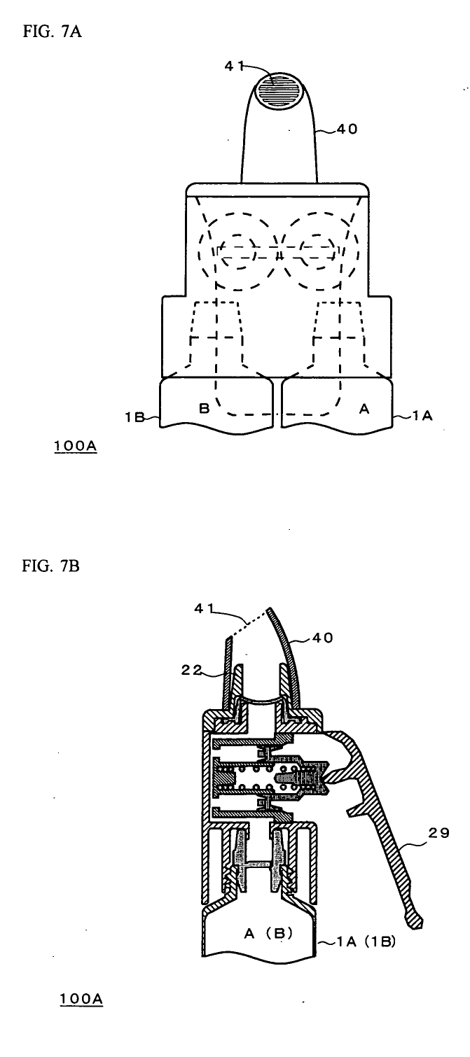

For example, as shown in FIGS. 7A and 7B, the discharge nozzle 22 may be covered with a tip member 40 having a plurality of open slits 41 at the top opening portion or with a tip member (not shown) having a meshed top opening portion. This arrangement provides a wider contact area of the nozzle with the head skin, thereby making it possible to alleviate the stimulus to the head skin when a hair cosmetic is directly applied to hair through the discharge nozzle 22. Furthermore, through the slits 41 or the mesh, it is possible to produce a turbulent flow of the first agent and the second agent in the discharge nozzle 22, thereby facilitating the mixing of both the agents after having been discharged through the nozzle.

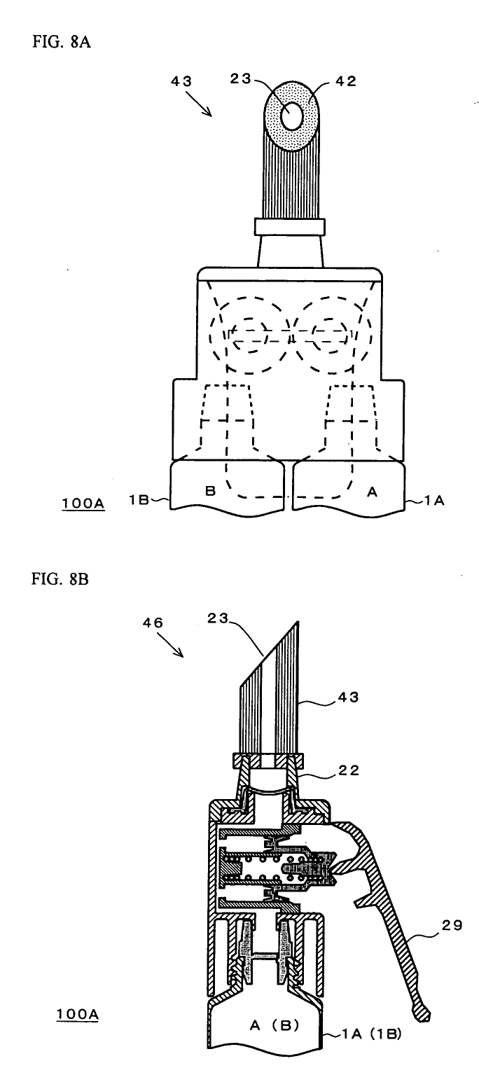

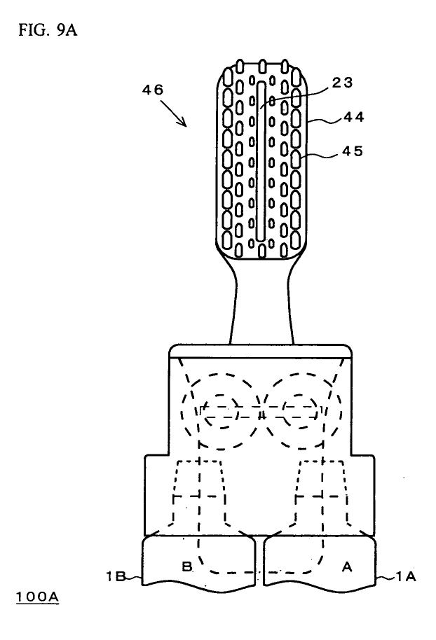

As shown in FIGS. 8A and 8B, the discharge nozzle 22 may also be provided with a cylindrical application tool 43 that has a bristle portion 42 around the discharge outlet 23. This arrangement will facilitate direct partial dyeing or the like using the dispensing device 100A.

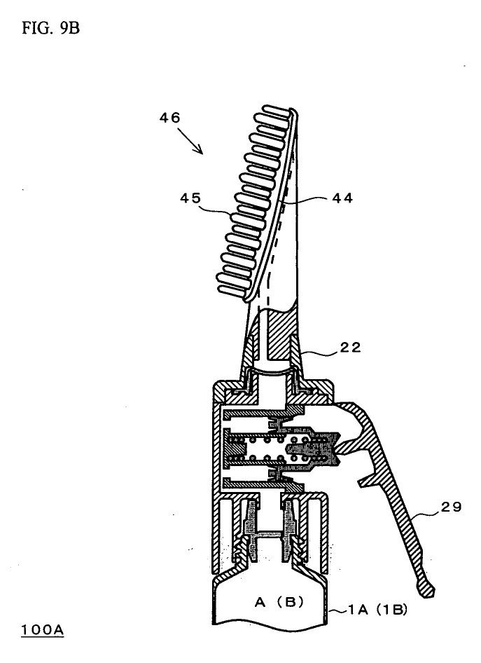

As shown in FIGS. 9A and 9B, the discharge nozzle 22 may also be provided with a brush 46 which has a plurality of brush teeth 45 located on a rectangular base 44. The discharge outlet 23 opens at the central portion of the brush 46. This arrangement facilitates dyeing of the whole hair using the dispensing device 100A.

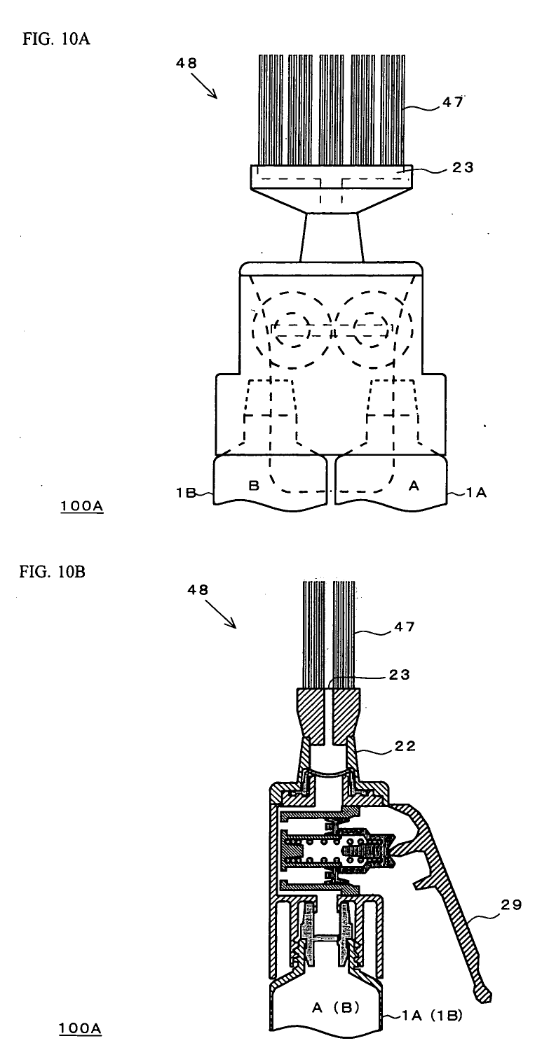

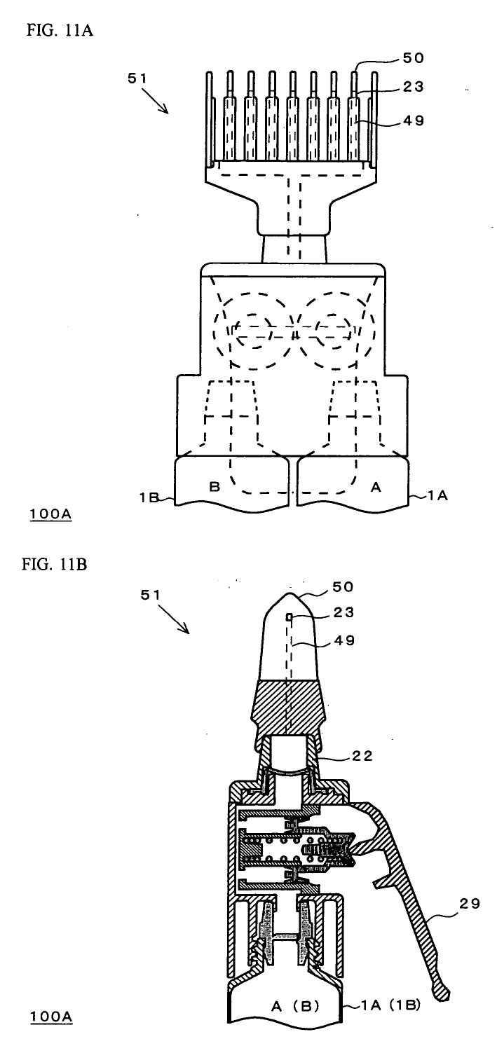

Other than the aforementioned arrangements, as shown in FIGS. 10A and 10B, the discharge nozzle 22 may also be provided with a brush-shaped application tool 48 in which bristles 47 extending in the longitudinal direction of the containers 1A and 1B are located around the slit-shaped discharge outlet 23 that extends in the direction of arrangement of the two containers 1A and 1B. As shown in FIGS. 11A and 11B, the discharge nozzle 22 may also be provided with a hair clipper type application tool 51 in which plate-shaped comb teeth 50 each having a flow path 49 formed therein and a discharge outlet 23 opened on both surfaces thereof. The teeth 50 extend in the direction of the containers 1A and 1B and are arrayed along the direction of thickness of the comb teeth.

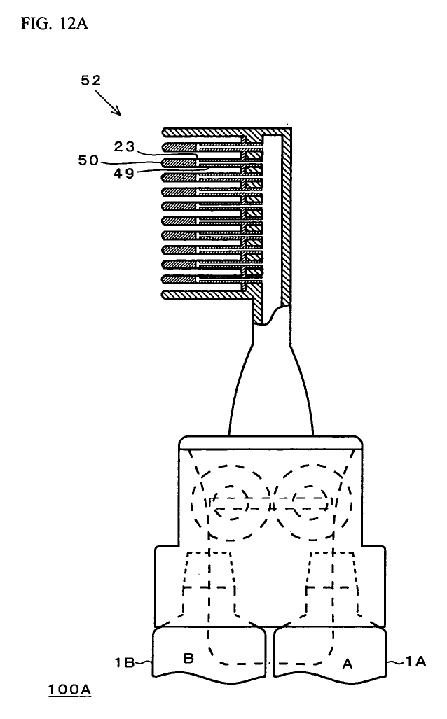

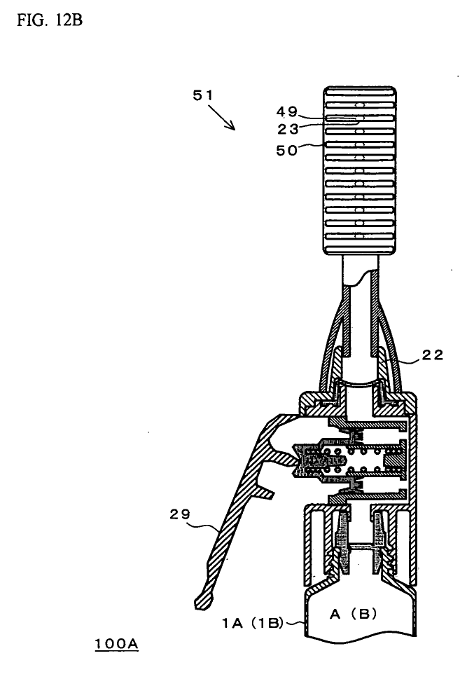

Alternatively, as shown in FIGS. 12A and 12B, the discharge nozzle 22 may also be provided with a hair dyeing application tool 52 in which plate-shaped comb teeth 50 each having a flow path 49 formed therein and a discharge outlet 23 opened on both surfaces thereof. Teeth 50 extend generally in the direction of arrangement of the two containers 1A and 1B and are arrayed in the direction of thickness of the comb teeth. These arrangements will also facilitate dyeing of the whole hair without preparing an additional hair dyeing brush or hair dyeing comb.

The hair cosmetic dispensing tool according to the present invention is configured such that the first and second containers of the dispensing device of the present invention are filled with the first agent and the second agent of a hair cosmetic, respectively. Thus, according to the hair cosmetic dispensing tool of the present invention, the first and second agents of a hair cosmetic are separately stored, and at the time of discharge, the first and second agents of the hair cosmetic can be discharged at the same time through one lever manipulation with reduced effort.

The hair cosmetic may be a two-part type hair dye that is composed of a first agent containing an oxidation dye or a direct dye and an alkaline agent, and of a second agent containing an oxidizing agent such as hydrogen peroxide. Alternatively, the hair cosmetic may also be a two-part type hair bleach that is composed of a first agent containing an alkaline agent and a second agent containing an oxidizing agent such as hydrogen peroxide. Among other things, as the alkaline agent serving as the first agent, ammonia and ammonium salt may be preferably employed in combination, thereby preventing the ammonia from volatilizing from the container. A preferable form of such a two-part type hair cosmetic may include a first agent which contains 0.01 to 3 weight percent of ammonia in an aqueous medium and 0.01 to 10 weight percent of ammonium salt, and a second agent which contains hydrogen peroxide in an aqueous medium. Here, for example, the ammonium salt may be ammonium phosphate, ammonium chloride, ammonium nitrate, or ammonium sulfate.

Furthermore, the first agent preferably contains a cationic surface-active agent, and the first and second agents may preferably contain a nonionic surface-active agent, high-grade alcohol, or silicone. This provides improved operability at the time of hair dyeing such as enhanced effects of hair dyeing, bleaching, and conditioning as well as prevention of drooping of liquids.

The dispensing device according to the present invention is suitable for quantitative measuring and simultaneous discharging of each component agent of a multiple-part type agent, which starts a chemical reaction by mixing the multiple agents, such as a hair cosmetic including a two-part type hair dye or bleaching agent and a two-part type adhesive.

1. A dispensing device comprising:
a plurality of containers each for accommodating a liquid content;
a pump device in fluid communication with the plurality of containers; and
a lever for actuating a piston of the pump device,
wherein one lever operation allows the liquid contents accommodated in the respective containers to be discharged simultaneously through a discharge outlet,
the pump device has a first cylinder in fluid communication with a first container, a first piston provided within a first cylinder, a second cylinder in fluid communication with a second container, and a second piston provided within a second cylinder,
the lever acts upon each piston at the same time,
each liquid content discharge path in fluid communication with each cylinder communicates with one discharge valve upstream of the discharge outlet, where the discharge valve is formed of an elastic valve with a slit and covers opening ends of the plurality of discharge paths; and
the liquid contents discharged from each cylinder are allowed to pass through the discharge valve to join into one.

2. The dispensing device according to claim 1, wherein the discharge valve is provided, on the cylinder side, with a check valve actuation restrictor member for restricting the discharge valve from being deformed to allow the discharge valve not to be deformed and thereby opened when the discharge valve is subjected to an excessive force exerted thereon to close the discharge valve.

3. The dispensing device according to claim 1, wherein a suction inlet of each cylinder on the container side is provided with an intake valve.

4. The dispensing device according to claim 1, wherein the first cylinder and the second cylinder are arranged to allow the first piston and the second piston to be displaced in the same direction, and the lever is a one lever handle for acting upon the first piston and the second piston at the same time.

5. A dispensing container according to claim 1, wherein a main-body housing of the pump device is provided with a grip portion extending in a longitudinal direction of the container.

6. A dispensing container according to claim 1, further comprising a case enclosing the containers.

7. The dispensing device according to claim 1, wherein the containers are reduced in inner volume according to a discharged amount of the liquid content.

8. A hair cosmetic dispensing tool wherein a first agent and a second agent of a hair cosmetic are filled in the first container and the second container of the dispensing device according to claim 1.

9. A dispensing device comprising:
a first container configured to accommodate a first liquid;
a second container configured to accommodate a second liquid;
a pump device in fluid communication with each of the first container and the second container, the pump device including a first cylinder in fluid communication with a first container, a first piston provided within a first cylinder, a second cylinder in fluid communication with a second container, and a second piston provided within a second cylinder;
a discharge valve formed of an elastic valve with a slit and covering opening ends of a first liquid content discharge path and a second liquid content discharge path, the first liquid content discharge path in fluid communication with the first cylinder and in communication with the discharge valve upstream of a discharge outlet, the second liquid content discharge path in fluid communication with the second cylinder and in communication with the discharge valve upstream of the discharge outlet; and
a lever for actuating a piston of the pump device, the lever configured to act on the first piston and the second piston simultaneously so as to simultaneously discharge the first and second liquid contents through the discharge outlet when operated.

10. The dispensing device according to claim 9, further comprising:
a check valve actuation restrictor member configured to prevent flow from entering the device.

11. The dispensing device according to claim 9, further comprising:
an intake valve on a container side of each suction inlet of each cylinder.

12. The dispensing device according to claim 9, wherein the first cylinder and the second cylinder are arranged to allow the first piston and the second piston to be displaced in the same direction, and the lever is a one lever handle for acting upon the first piston and the second piston at the same time.

13. A dispensing container according to claim 9, further comprising:
a grip portion extending in a longitudinal direction of the container and connected to a main-body housing of the pump device.

14. A dispensing container according to claim 9, further comprising:
a case enclosing the containers.

15. The dispensing device according to claim 9, wherein the containers are reduced in inner volume according to a discharged amount of the liquid content.

16. A hair cosmetic dispensing tool wherein a first agent and a second agent of a hair cosmetic are filled in the first container and the second container of the dispensing device according to claim 9.
